(19) United States
(12) Patent Application Publication
(10) Pub. No.: US 2006/0013991 A1
(43) Pub. Date: Jan. 19, 2006

(54) Pallets and methods for manufacture and use thereof

(76) Inventor: Hendricus Antonius Hoogland, Ganimedesstraat (NL)

Correspondence Address: HOFFMANN & BARON, LLP, 6900 JERICHO TURNPIKE, SYOSSET, NY, 11791, US

(21) Appl. No.: 10/529,329

(22) PCT Filed: Sep. 26, 2003
(86) PCT No.: PCT/NL03/00658

§ 371 Date: May 23, 2005

(30) Foreign Application Priority Data
Sep. 26, 2002 (NL) 1021546

(51) Int. Cl. B29C 45/00

(52) U.S. Cl. 428/119; 264/320; 264/328.1

(57) ABSTRACT

The invention relates to a pallet, provided with a top deck and a bearing construction which are attached onto each other, while top deck and bearing construction are at least partly manufactured from plastic, while in the top deck and/or in the bearing construction and/or between the top deck and the bearing construction supporting means are received and wherein the top deck and the bearing construction are attached onto each other.

The invention relates to pallets and to methods for manufacture and use thereof.

Pallets are used when transporting packages such as boxes, crates and the like. Such pallets can be taken up and transported together with the packages stacked thereon and are usually manufactured from wood. It has already been proposed to manufacture such pallets through injection molding. However, this is relatively expensive since, due to the size, heavy and expensive apparatuses are required and, moreover, relatively much plastic is to be used, with complicated designs, in order to provide the pallet with sufficient load bearing capacity and stability. A further drawback of the known plastic pallets is that they are subject to deformations, in particular creep in the plastic, thereby causing the pallets to become instable and unusable relatively quickly.

The invention contemplates providing an alternative plastic pallet as well as methods for the manufacture and use thereof A pallet according to the invention is characterized by the features of claim 1.

By building up a pallet according to the invention from a top deck and a bearing construction, which can be manufactured independently of each other and subsequently be assembled, the advantage is achieved that the different parts can be manufactured on relatively simple apparatuses and that, moreover, a relatively large freedom of design is obtained for forming the parts and hence, the pallet as a whole. By using bearing constructions which can be included in or between these parts, the load bearing capacity, the rigidity and/or the creep can, for instance, be advantageously influenced, while the pallet as a whole can be of relatively light design. In particular, such a pallet can be manufactured from relatively little material. A further advantage of such a pallet is that the different parts can be manufactured from different materials, if this is desired. Naturally, also the same material can be used for top deck and bearing construction.

With a pallet according to the invention the top deck and bearing construction can be fixedly interconnected such that they cannot be separated from each other without damage. However, it is also possible to couple the top deck to the bearing construction with the aid of detachable connections, such as snap fingers or the like, so that a top deck and/or a bearing construction can be replaced or, for instance, support means can be exchanged, replaced or removed or moved, when, for instance, a pallet is to be made suitable for a different use.

Preferably, the support means are designed to prevent, at least reduce creep and/or shrinkage of the bearing construction and/of the top deck, so that deformations of the pallet are prevented. Moreover, thus, the top deck and bearing construction are even better prevented from detaching from each other as a result of, for instance, relaxation.

It is preferred that the material of the support means has a higher elasticity modulus than that of the top deck and/or the bearing construction. As a result, with relatively slim support means of simple design, rigidity improvements can be obtained, while the support means can be of relatively light design.

With a pallet according to the invention, the support means can have an at least top deck supporting, rigidity-enhancing function and can be manufactured from metal or from plastic, in particular fiber- or glass-reinforced or otherwise reinforced plastic.

In a further advantageous embodiment, a pallet according to the invention is characterized in that the bearing construction comprises at least two stringers extending substantially parallel to each other, provided with bearing elements on which the top deck rests. The stringers have a longitudinal direction, while at least a part of the support means extend in a direction that includes an angle with this longitudinal direction, i.e. an angle deviating from 0 or 180°. Preferably, this angle is between 5° and 175° relative to the longitudinal direction and is, preferably, approximately 90°.

Thus, a pallet is obtained having a relatively great rigidity both in the longitudinal direction of the stringers and in the direction transverse thereto, while the construction can be of relatively light design.

With a pallet according to the invention, further, a part of the support means can extend in a direction approximately parallel to the longitudinal direction of the stringers of the bearing construction, preferably wholly or partly in the bearing construction, so that the rigidity of the stringers and the load bearing capacity thereof can be increased in a simple manner.

Preferably, the support means are substantially confined in plastic of the top deck, the bearing construction or both. As a result, the support means are screened off from the surroundings in a suitable manner, so that they are well protected against, for instance, corrosion, pollution and the like. This is particularly advantageous when pallets are used in chemically aggressive surroundings or when used in combination with, for instance, foodstuffs, medical uses and the like. Preferably, the outside surfaces of the pallets are well cleanable, for instance of relatively smooth and closed design.

The invention further relates to a pallet, characterized by the features of claim 13. Preferably, such a pallet is designed as described hereinabove.

With such a pallet according to the invention, drive-on elements are provided, connected to channel elements such that via the inclined drive-on elements, a rolling container can be rolled by its wheels into these channel elements. In each channel element, at least one recess is provided in which, each time, a wheel of the rolling container can be received for fixing the rolling container onto the pallet. Thus, in a simple manner, it becomes possible to position rolling containers on pallets and to take them up, transport and or otherwise manipulate them together with the pallet.

In an advantageous further embodiment, a pallet according to the invention is characterized in that in a bottom of the or each recess, an opening is provided through which, from an underside of the pallet, an ejector element can be inserted. With this ejector element, during use, a wheel of the rolling container can be pushed from a recess so that the rolling container can be rolled from the pallet in a relatively simple manner. This can, for that matter, also be done by slightly tilting the rolling container such that the wheel is pulled from the respective recess.

The invention further relates to an assembly of a pallet and at least one rolling container, characterized by the features of claim 16.

Such an assembly is particularly advantageous because the rolling container and the pallet are geared to each other. Preferably, at least two rolling containers can be received side by side on the pallet, with the wheels in the recesses, on the drive-on elements or on a surface contiguous thereto, respectively.

In a further advantageous embodiment, further, a push-out device with ejector elements is provided on which the pallet can be laid such that the wheels of a rolling container are slightly pushed upwards on the pallet, so that rolling the rolling container from the pallet is further simplified.

The invention further relates to a method for manufacturing a pallet, characterized by the features of claim 19.

With such a method, in a particularly simple manner, a pallet can be manufactured from relatively little material with good properties of use.

The invention further relates to a method for transporting a rolling container, characterized by the features of claim 21.

By using pallets according to the invention, at least assemblies according to the invention, the advantage is achieved that rolling containers can be manipulated in a particularly simple manner by fixedly arranging them on a pallet, for instance in pairs, while, detached from the pallet, the rolling containers can be used individually and can be, for instance, moved by rolling. The pallets with rolling containers can be easily manipulated with, for instance, pallet carts, forklifts and the like and can be stacked at wish.

Preferably, pallets and rolling containers according to the invention have standard sizes, for instance fitting within Euro-pallet systems.

In the further subclaims, further advantageous embodiments of pallets and methods according to the invention are described.

In clarification of the invention, pallets, assemblies and methods according to the invention will be further elucidated with reference to the drawing. In the drawing:

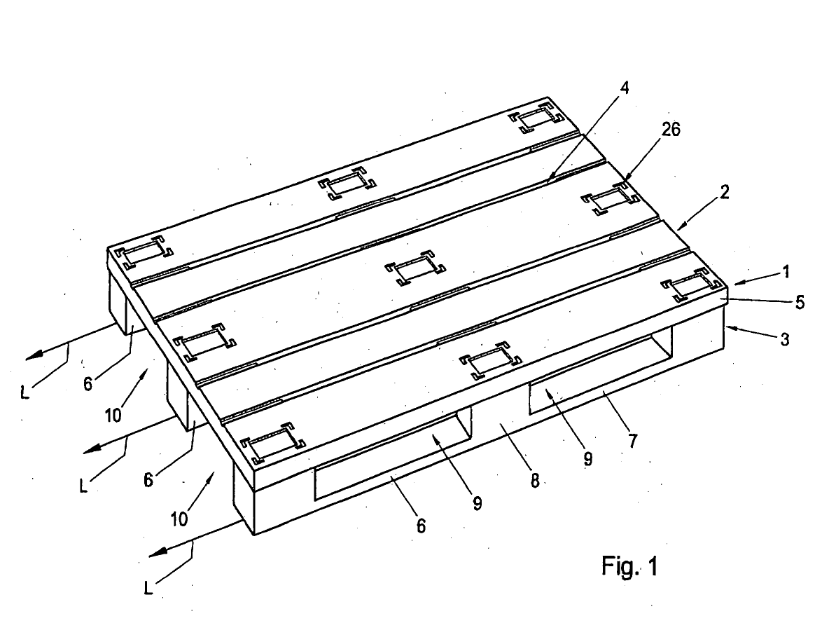

FIG. 1 shows, in perspective top plan view, a pallet according to the invention;

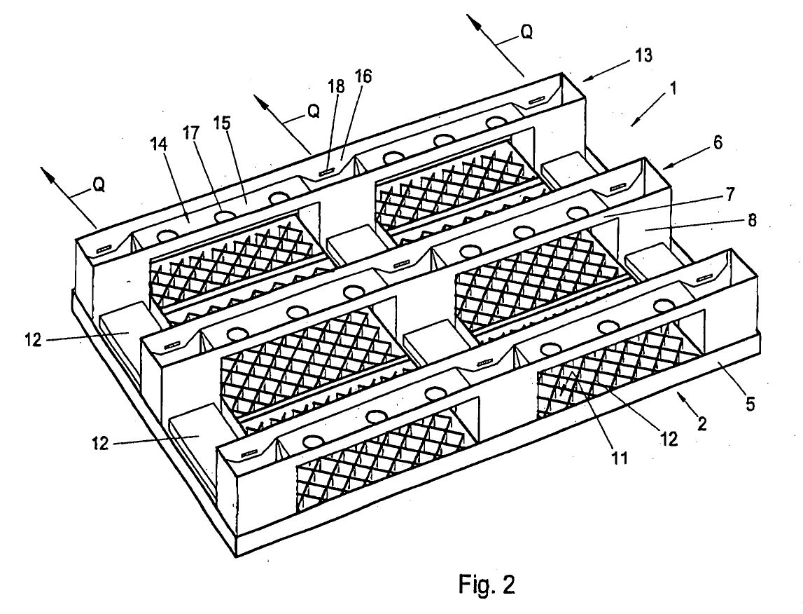

FIG. 2 shows, in perspective bottom view, a pallet according to the invention;

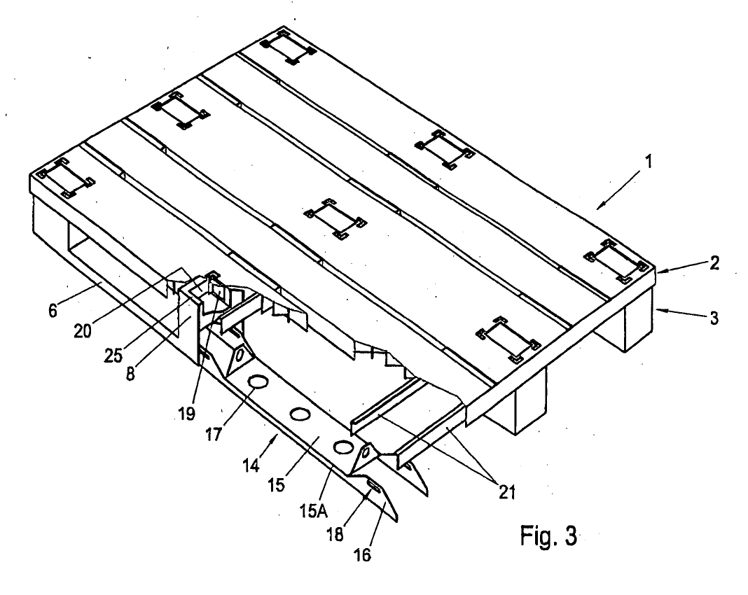

FIG. 3 shows, in perspective, partly broken away top plan view, a pallet according to FIG. 1;

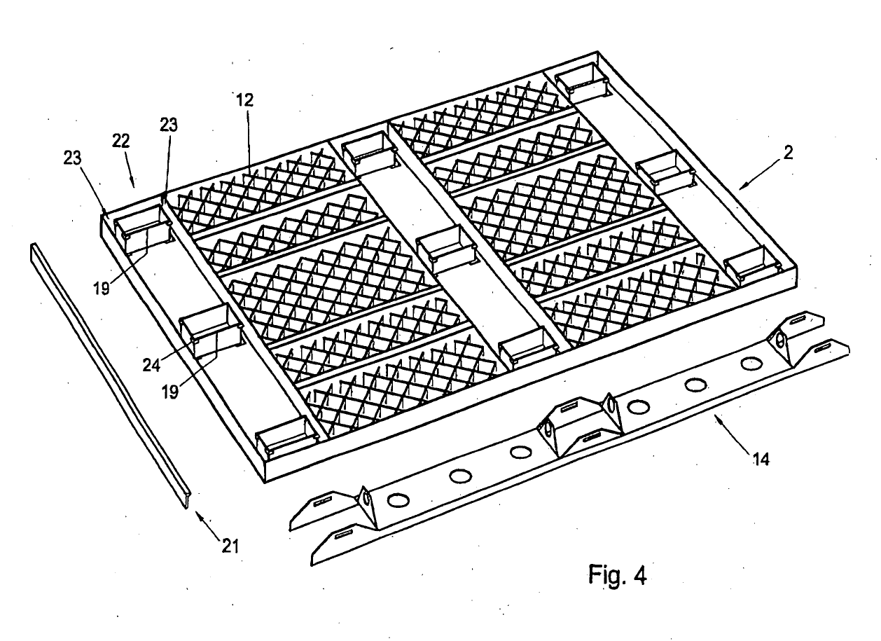

FIG. 4 shows, in perspective bottom view, a top deck of a pallet according to the invention, with support means next to it;

FIG. 5 shows, in perspective view, a pallet according to the invention in an alternative embodiment, with a rolling container next to it;

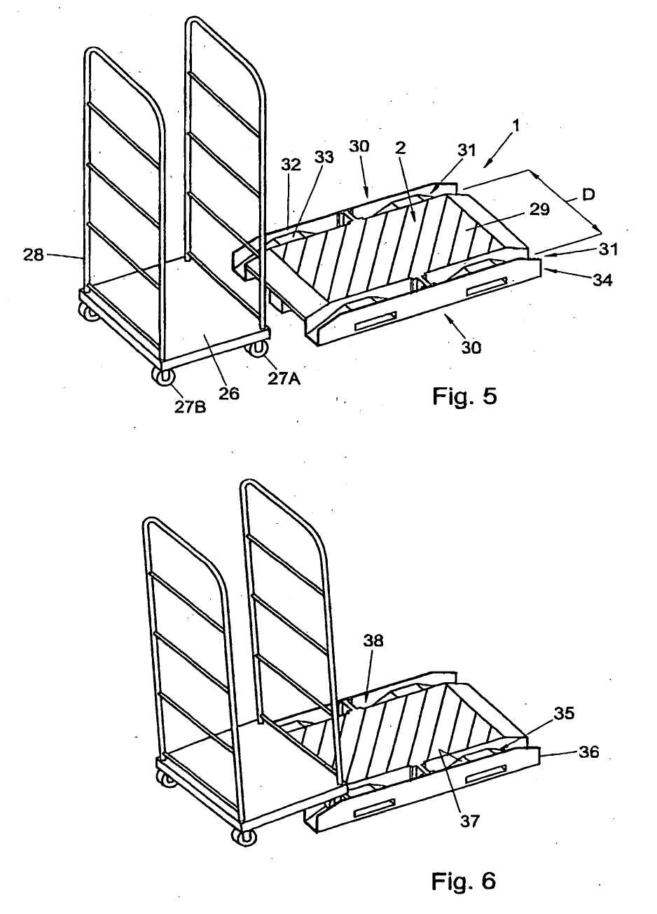

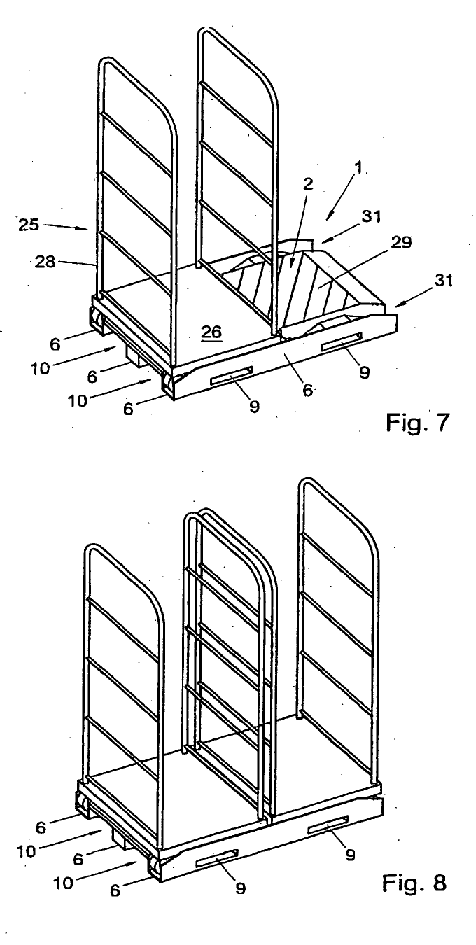

FIGS. 6-8 show in three steps the placing of two rolling containers on a pallet according to the invention;

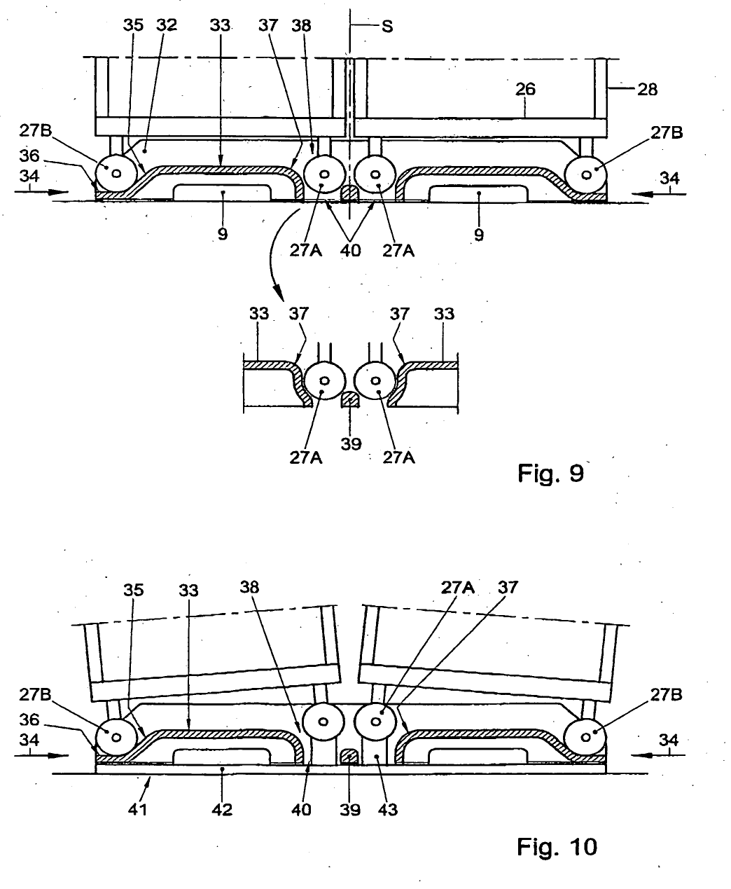

FIG. 9 shows, in cross sectional side view along the line IX-IX in FIG. 5, a pallet according to FIGS. 5-8 with a rolling container thereon;

FIG. 10 shows the side view according to FIG. 9, with push-out device and;

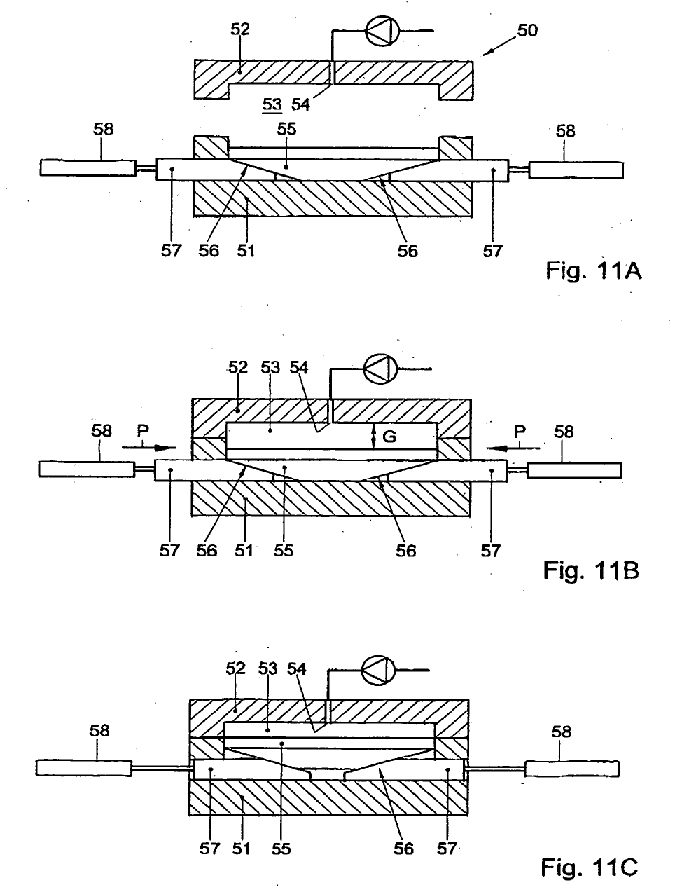

FIGS. 11A-C show, in cross sectional side view, schematically, the principle for a mold for manufacturing a top deck or a bearing construction for a pallet according to the invention.

In this description, identical or corresponding parts have identical or corresponding reference numerals. Combinations of separate parts of devices according to the invention or associated methods are expressly understood to fall within the framework of the invention as outlined by the claims and are expressly incorporated in this application.

FIG. 1 shows, in perspective top plan view, a pallet 1 according to the invention, manufactured for the larger part from plastic, for instance PE, PP, ABS, PC or any other suitable plastic or combination of plastics. The pallet 1 is formed from a top deck 2 and a bearing construction 3, placed on top of each other and interconnected, for instance with the aid of snap means, clamping means or, for instance, by gluing, welding or the like. The top deck 2 is substantially closed and has a number of slot-shaped openings 4, but, if desired, can also be designed in a different manner, for instance having a honeycomb structure, projections, profile or the like. Variations thereon will be immediately clear to the skilled person. At the edge, the top deck 2 is provided with a skirt 5, extending downwards. The bearing construction 3 comprises three stringers 6, having a longitudinal direction L, schematically represented in FIG. 1 by an arrow L. The stringers 6 extend parallel to each other and are substantially built up from a supporting part 7 which has a relatively small height with, thereon, three bearing elements 8, on which the top deck 2 is borne. Between the bearing elements 8, each time, an opening 9 is provided through which, for instance, the tines of a pallet cart or fork lift truck can be inserted, so that the pallet can be engaged and lifted from all sides. The connection between the top deck 2 and the bearing construction 3 is at least such that the pallet can be lifted at the top deck, provided or not provided with a load.

In FIG. 2, in perspective bottom view, a pallet 1 according to the invention is shown, in which the underside 11 of the top deck 2 can be seen, provided with a honeycomb structure 12 built up from ribs, for enhancing the bearing capacity and weight reduction. Further, the stringers 6 with supports 7 and bearing elements 8 can be clearly seen. The bearing elements 8 are interconnected by cross supports 12 belonging to the bearing construction 3, which interconnect the upper ends of the bearing elements 8 remote from the supports 7, and which cross supports 12 have a longitudinal direction Q, represented in FIG. 2 by arrow Q. The longitudinal direction Q of the cross supports 12 extends approximately at right angles to the longitudinal direction L of the stringers 6, so that the bearing construction has a substantially rectangular base plane. The sizes thereof correspond, for instance, to the dimension of the base of a Europallet, although any other suitable size can be used too.

As is visible in FIG. 2, the bearing elements 8 and the supports 7 are of substantially hollow design at the side 13 facing downwards during use, while in the supports 7 a first supporting element 14 is arranged in the form of a metal profile, as will be further elucidated with reference to FIGS. 3 and 4. These supporting elements 14 are designed as steel profiles with, between the bearing elements 8, flat parts 15 and in the bearing elements 8, upstanding lips 16. Optionally, in the flat parts 15 and lips 16, openings 17, 18, respectively, can be provided through which plastic of the stringers 6 can project, for obtaining a good connection.

In FIG. 3, a pallet 1 according to the invention is shown, in perspective top plan view, while a corner part of the pallet 1 is partly broken away, in clarification of the construction. It is clear that with the aid of downwardly extending edges 19, the top deck 2 is attached in the upper ends of the bearing elements 8, which are provided to that end with box-like recesses with a shape matching the edge 19. In the top deck 2, at least between the top deck 2 and the bearing construction 3, second supporting elements 21 are provided, extending in a direction approximately parallel to the longitudinal direction Q of the cross supports 12. At each row of bearing elements 8, interconnected by cross supports 12, each time, a pair of such second supporting elements 21 are provided, which have at least a rigidifying and supporting function. Preferably, the second supporting elements 21 are clamped in between the top deck 2 and the bearing construction 3 and confined between the top deck 2 and the cross supports 12 or bearing elements 8, respectively, screened off from the surroundings. Thus, pollution and, for instance, damage through corrosion or the like is prevented in a simple manner.

Further, in FIG. 3, a first supporting element 14 is clearly visible, in FIG. 3 at the bottom of the front stringer 6. From this, it is clearly visible that this supporting elements 14 can, for instance, be a folded plate work, while the flat parts 15 with folded edges 15A and lips 16 are visible as well as the openings 17 and 18. When manufacturing a bearing construction 3, the first supporting elements 14 can, for instance, in a simple manner, be inserted into a mold whereupon plastic is injected all around so that a one-piece, fixed construction is obtained. In a comparable manner, the second supporting elements 21 can be inserted into a mold and be injected in the bearing construction 3, or the top deck 2. However, it is preferred that the second supporting elements 21 are kept separate and are only fitted in their place when the top deck 2 and the bearing construction 3 are being assembled. Preferably, the supporting elements 14 and 21 are manufactured from a material with an elasticity modulus which is higher than that of the plastic from which the top deck and/or the bearing construction have been manufactured, while, moreover, the material of the supporting elements 14, 21 also exhibits a different shrinkage, preferably a smaller shrinkage and/or a different creep, preferably less creep than the plastics. For the supporting elements 14, 21, for instance, in a suitable manner, metal can be used, such as sheet iron, aluminum or the like, or glass or otherwise filled plastic such as filled nylon, polyester or the like. Naturally,.through suitable profiling of the supporting elements 14, 21, the load bearing capacity can be further enhanced. For instance, in the embodiment shown in FIG. 3, each second supporting element 21 is of a somewhat L-shaped design. This offers the advantage that, furthermore, in a simpler manner, a good connection and confinement between the top deck and the bearing construction can be obtained. It will, however, be clear that, naturally, also any other profile is well possible.

In the embodiment shown in FIG. 3, the cross supports 12 have been omitted, at least not drawn. It will be clear that such cross supports offer the advantage that the bearing construction 3 can be manufactured in one piece and can be connected, as such, to the top deck 2. However, it will be clear that a pallet according to the invention can also be designed without cross supports, while three loose stringers 6 are manufactured and connected to the top deck separately from each other. Also, with a pallet according to the invention, for coupling with the top deck 2, the stringers 6 can be connected only by the second supporting elements 21, which may have been placed after injection molding the stringers 6 but can also be integrally formed therewith.

In FIG. 4, schematically, in bottom view, a top deck 2 for a pallet 1 according to the invention is shown, with, next to it, a first supporting element 14 and a second supporting element 21. Here, the honeycomb structure 12 is clearly visible, as well as three channel-shaped elements 22, provided on both sides with grooves 23 in which the supporting elements 21 can be received. Between these grooves 23 the tubular edges 19 are clearly visible which can be pressed in the box-like open upper side 20 of the bearing elements 8. In the exemplary embodiment shown, the edges 19 are provided with clamping projections 24 extending outwardly and which can engage below the upper edges 25 of the upper ends 20 of the bearing elements 8 for obtaining a fixed connection between the top deck 2 and the bearing construction 3. It will be clear that then, the supporting elements 21 are locked in the grooves 23 between the top deck 2 and the cross supports 12. Preferably, the bottom surfaces of the cross supports 12 are at some distance from the top deck 2, so that rigidifying tubular profiles are obtained.

It will be clear that the supporting elements 21 can include any desired angle with the longitudinal direction L of the stringers 6, in particular deviating from 0°, for instance between 5° and 175°.

If the top deck 2 is attached to the bearing construction 3 with the aid of only the clamping projections 24 or comparable means, it can, with some skill, be taken from the bearing construction 3 without damage, for instance with a tool suitable to that end which can be inserted through openings 26 in the top deck 2 for pushing the clamping projections 24 back. Thus, the possibility can be offered, for instance, to replace a top deck, or exchange a bearing construction, while, moreover, the supporting elements 21 can be replaced, taken away or, conversely, placed, depending on the use of the pallet, or for repairs. For instance, if a less rigid pallet can suffice, the number of supporting elements 21 can be reduced, so as to reduce the weight, or they can be replaced by supporting elements 21 of different material, for instance if a pallet according to the invention is to be used in a food setting, a clean room or the like in which metal is less suitable.

In FIGS. 5-10, an alternative embodiment of a pallet 1 according to the invention is shown, suitable for carrying rolling containers 25. Rolling containers 25 have a floor element 26, borne by wheels 27, in particular two pairs of wheels 27A, 27B, of which, preferably, at least two wheels can swivel. The rolling containers can be provided with sidewalls 28 or be designed without sidewalls, while, furthermore, a structure can be provided for specific uses such as laundry bags and the like. In the drawing, as an example, only rolling containers with sidewalls have been drawn.

In this embodiment, the pallet 1 has top deck 2 with an upper side 29, three stringers 6 which extend parallel to each other and define openings 10 for, for instance, tines of a pallet cart or forklift. The pallet 1 can be manufactured in a way as described hereinabove with reference to FIGS. 1-4, but can also be manufactured differently, in particular in one piece.

In this embodiment, on two longitudinal sides 30, the pallet has channels 31 extending in the longitudinal direction L of the stringers 6. The mutual distance D of the channels substantially corresponds to the mutual distance between the wheels 27 of each pair of one rolling container which is to be borne on the pallet 1. Therefore, the rolling container 25 can be rolled by the pairs of wheels into the channels 31, being guided, then, by the sidewalls 32 of the channels 31. In FIGS. 9 and 10, in cross sectional side view, schematically, a channel 31 of the pallet 1 is shown, with two rolling containers 25 therein. The pallet 1 is substantially mirror symmetrical relative to the plane S in FIG. 9. Here, only the left hand part will be discussed further. The pallet 1 is, for that matter, substantially mirror symmetrical with respect to a plane at right angles to this plane S through the center of the top deck 2.

Each channel 31 comprises a running surface 33 extending substantially horizontally, parallel to the upper side 29, which running surface, on the side facing the small side 34 of the pallet 1, connects to an inclined drive-on element 35 which merges into a positioning surface 36 on which a wheel 27 of the rolling container 25 can stand. At the opposite side, via a curved surface 37, the running surface 33 connects to a recess 38 in the channel 31, in which a wheel 27 of the same rolling-container 25 can be received. The bottom 39 of the recess 38 can be provided with a hole 40, for reasons to be mentioned hereinafter. Insertion openings 9 for tines of a forklift or pallet cart are provided below the running surface 33.

An assembly of a pallet 1 and a rolling container 25 can be used as follows.

A pallet 1 is laid with the underside on a floor. With one pair of wheels 27, the rolling container 25 is placed next to the positioning surfaces 36 of two channels 31 and then, by these wheels, rolled over the positioning surfaces 36 and the drive-on elements 35 onto the running surfaces 33 and, from there, into the recesses 38. The wheels of the other pair 27B are thereby pulled onto the positioning surfaces since the sizes of the rolling container 25 and the pallet 1 are thus geared to each other. The depth and profile of the channels 31 are selected such that the rolling container 25 can be rolled onto the pallet 1 in a simple manner, that the tines can be inserted into the insertion openings 9 or 10 and that, preferably, with the rolling container rolled onto the pallet, the floor element 26 of the rolling container rests on the top deck 2 of the pallet 1. As a result, the rolling containers 25 are well confined in a positionally fixed manner.

Naturally, in order to obtain an even better confinement, further measures can be taken, such as a fitting profile of the curved surfaces such that the wheels in the recesses are urged below these curved surfaces 37 to some extent and can only be rolled therefrom by, first, pushing the rolling container slightly further into the channel 31. Such a profile has been sketchily drawn at the bottom of FIG. 9. Also, to that end, different means can be provided, apparent to the skilled person.

As appears from the Figures, in the embodiment shown, two rolling containers can be placed side by side on the pallet 1, so that a standard package is obtained. Also, three channels 31 could, for instance, be provided next to each other, while two are located directly side by side in or above the middle stringer, so that two times two rolling containers can be arranged on the pallet 1 side by side, for instance when smaller rolling containers such as dollies are used.

Pallets 1 with rolling containers 25 positioned thereon can simply be taken up in their entirety as an assembly and be transported to a destination or be stored. Upon arrival at a destination, the rolling containers are then rolled from the pallet 1 and used further. The assemblies of pallets and rolling containers can even be stacked on top of each other, for economical use of space.

In FIG. 10, a pallet 1 according to FIGS. 5-9, provided with holes 40 in the bottoms of the recesses 38 has been placed on an push-out device 41. In this embodiment, the push-out device 41 is shown as a flat plate 42 with ejector elements 42 on it in the form of blocks that can project through the holes 40. When a pallet 1 with rolling containers is placed on the push-out device, then, the wheels 27 positioned near each other in the recesses 38 will rest on the blocks 43 and thus be pushed upwards, partly from the recesses 38, so that the rolling containers 25 can be rolled onto and from the pallet 1 in a particularly simple manner. A rolling container 25 can, for that matter, also be rolled from the pallet by tilting this somewhat about the wheels on the positioning surfaces.

In FIG. 11A-C, schematically, in cross sectional side view, a mold 50 is shown for manufacturing a top deck or bottom deck or even an entire pallet 1 according to the invention. For simplicity's sake, specific parts for forming profiles and the like have been omitted. A comparable mold and associated description of the method are described in the non-prepublished patent application NL 1019739, which application, as to the mold and method, is incorporated herein by reference.

The mold 50 according to FIG. 11 comprises a first part 51 and a second part 52, which parts are moveable relative to each other by means (not shown) such as a press, spindles or in any other suitable manner, between an opened position as shown in FIG. 11A and a closed position as shown in FIG. 11B. In the closed position, the two parts 51, 52 define a mold cavity 53 in which a pallet (part) can be manufactured by introducing plastic therein through the inlet opening 54. In the first part 51, a moveable slide 55 is included, which defines, for instance, one side of a pallet (part), for instance a top or bottom surface of a top deck or a bearing construction or an upper or lower side of a complete pallet 1. At the side remote from the mold cavity 53, this slide is provided with two inclined surfaces 56, below which wedges 57 are arranged which, with the aid of piston-cylinder assemblies 58 or different suitable means, are moveable in the direction P between a retracted position as shown in FIG. 11A and B and an extended position as shown in FIG. 11C. By moving the wedges, the slide 55 is moved between a lower position shown in the drawing in FIGS. 11A and B, and an upper position as shown in FIG. 11C.

The mold according to FIG. 11 can be used as follows.

The mold is closed from the opened position, while the slide 55 is retracted to the lowest position, i.e. at a relatively large distance G from the opposite wall 59 of the mold cavity. The distance G is considerably greater than the wall thickness of the pallet (part) which is to be formed therebetween. As a result, particularly much space is available for injection of plastic, while the plastic in the mold cavity 53 will experience little resistance and therefore can be introduced into the mold cavity with low injection pressure. Moreover, the distance the plastic travels in the mold cavity after injection is relatively short. The projected surface of the total amount of plastic that is introduced into the mold cavity, with the mold in the position as shown in FIG. 11B, is considerably smaller than the projected surface of the pallet (part) to be eventually formed.

After the desired amount of plastic has been introduced into the mold cavity 53, the slide 55 is moved to the position shown in FIG. 11C, by moving the wedges 55 towards each other. As a result, the plastic is urged away until it fills the entire mold cavity 53. Optionally, via the feed opening 54, some hold pressure can still be applied. Thereupon, the mold can be moved back to the position shown in FIG. 11A, so that the product can be taken out.

As a result of this combination of features, during injection, the mold 50 can be kept closed with relatively low closing pressure (approximately readable from standard tables for injection pressure with the respective plastic, projected surface and wall thickness with the mold in the position as shown in FIG. 11B), which closing pressure is many times lower than the injection pressure that would be necessary if the plastic were introduced directly into the mold cavity 53 with the mold in the position as shown in FIG. 11C. The fact is that then, the projected surface is much larger than with injection with the same amount of plastic in the mold cavity in the position according to FIG. 11B. Moreover, the fictitious wall thickness G in FIG. 11B is considerably greater. When moving the slide over 75% of the distance G between the positions in FIGS. 11B and 11C, the wall thickness decreases by 75% and the projected surface increases proportionally, i.e. by a factor of 4. This means, roughly, that upon injection in the position shown in FIG. 11B, the injection and closing pressure can be read from the relevant table with a relation projected surface of 1 and a wall thickness of 4, while, upon injection in the position according to FIG. 11C, this should be read at a relation projected surface of 4 and a wall thickness of 1. It will be directly clear to a skilled person that, hence, with a mold according to the invention, considerably smaller closing pressures and injection pressures can be applied than with conventional molds, so that a considerable cost saving can be effected, shorter cycle times are obtained and, moreover, in principle, smaller wall thicknesses can be achieved.

Use of such a mold 50, at least the method described for pallets according to the invention, is particularly advantageous because the projected surfaces of the parts to be injection molded are particularly large, which, with conventional techniques, would require particularly large devices.

With a method according to the invention, for that matter, also pallets in one piece can be formed without supporting elements.

It will be clear that a mold according to the invention, at least for use in a method according to the invention, can be designed in many comparable manners. It is of importance in particular that the slide can be moved after closure of the mold. Parts of the pallet according to the invention, for that matter, could also be manufactured with conventional techniques, for instance also with compression molding techniques.

The slide 55 can be moved relatively slowly to the position shown in FIG. 11C, but it is preferred that this be done relatively rapidly, so rapidly that adiabatic heat is supplied to the plastic. This has the advantage that when thermoplastic and comparable plastics are used, optionally, partially solidified plastic is made liquid again, at least obtains a lower viscosity so that the plastic can fill the entire mold cavity with even less pressure.

The invention is not limited in any way to the exemplary embodiments represented in the description and the drawing.

For instance, several parts can be assembled to form a pallet according to the invention, for instance several loose stringers and a top deck. Also, differently shaped top decks can be used, for instance of wholly or partly openwork design or provided with specific elements such as means for attaching straps or the like. A pallet according to the invention can have any desired size. Walls of rolling containers within an assembly according to the invention can be foldable or detachable for reducing return volume and increasing the possibilities of use. Other numbers of stringers and bearing elements, supporting elements, openings and the like can be used, according to need. These and many comparable variations, among which all possible combinations of elements as shown and described, are understood to fall within the framework of the invention as outlined by the claims.

1. A pallet, provided with a top deck and a bearing construction, wherein top deck and bearing construction are at least partly manufactured from plastic, while in the top deck and/or in the bearing construction and/or between the top deck and the bearing construction, supporting means are included while the top deck and the bearing construction are attached onto each other.

2. A pallet according to claim 1, wherein the supporting means are arranged for preventing, at least reducing creep and/or shrinkage of the bearing construction and/or the top deck.

3. A pallet according to claim 1, wherein the supporting means are manufactured from a material which has a higher elasticity modulus than the or each of the materials from which the top deck and the bearing construction have been manufactured.

4. A pallet according to claim 1, wherein the supporting means are manufactured from a material exhibiting creep and/or shrinkage which deviates from that of the material of the top deck and/or the bearing construction.

5. A pallet according to claim 1, wherein the supporting means have at least a top deck-supporting, rigidity-enhancing function.

6. A pallet according to claim 1, wherein the supporting means are at least partly manufactured from metal.

7. A pallet according to claim 1, wherein the supporting means are at least partly manufactured from plastic, in particular fiber or glass-reinforced or otherwise reinforced plastic.

8. A pallet according to claim 1, wherein the bearing construction comprises at least two stringers extending substantially parallel to each other, provided with bearing elements on which the top deck rests, which stringers have a longitudinal direction, and wherein at least a part of the supporting means extends in a direction including an angle with said longitudinal direction of between 5° and 175°, preferably an angle of approximately 90°.

9. A pallet according to claim 1, wherein the bearing construction comprises at least two stringers extending substantially parallel to each other, provided with bearing elements on which the top deck rests, which stringers have a longitudinal direction, and wherein at least a part of the supporting means extends in a direction approximately parallel to said longitudinal direction, preferably entirely or partly in the bearing construction.

10. A pallet according to claim 8, wherein the supporting means are at least substantially confined in plastic of the top deck and/or the bearing construction.

11. A pallet according to claim 10, wherein at least a part of the support means is injection molded in the pallet, at least in the top deck and/or the bearing construction.

12. A pallet according to claim 1, wherein the bearing construction comprises at least two and preferably three stringers extending substantially parallel to each other, wherein each stringer bears at least two and preferably three bearing elements extending above a top surface of the stringers, while in each stringer a supporting element is included for rigidifying and/or protecting the respective stringer from creep, while the spaces between the stringers and/or the spaces between the bearing elements, below the top deck are suitable for inserting tines of a forklift or pallet cart.

13. A pallet, in particular according to claim 1, wherein a top deck is provided and, at two opposite sides, a drive-on element which is at an inclination relative to the top deck and a channel connected thereto, in which channel a recess is provided at a distance from the respective drive-on element, such that, if the pallet has been laid on a floor with the top deck turned upwards, a trolley such as a rolling container can be rolled with two wheels over the drive-on elements arranged on both sides, via the channel into the said recess.

14. A pallet according to claim 13, wherein at two opposite sides of each channel a drive-on element has been provided.

15. A pallet according to claim 13, wherein in a bottom of the or each recess, an opening is provided through which, from an underside of the pallet, an ejector element can be inserted for lifting, during use, a wheel of a rolling container received in the respective recess.

16. An assembly of a pallet according to claim 13, and at least one rolling container with at least two pairs of wheels, wherein the dimensions of the pallet and the rolling container are geared to each other such that a first pair of wheels of the rolling container can be received in two recesses in the channel while the wheels of the other pair stand on the adjacent drive-on elements.

17. An assembly according to claim 16, wherein two rolling containers can be received on the pallet side by side, with the wheels in the recesses or on the drive-on elements, respectively.

18. An assembly of a pallet according to claim 13 and a push-out device, wherein the push-out device is provided with ejector elements which can be inserted through openings into the pallet when the pallet is laid on the ejector device such that a rolling container placed on the pallet is thereby slightly lifted, at least one pair of wheels of the rolling container in the recesses is pushed upwards.

19. A method for manufacturing a pallet, wherein a top deck and a bearing construction are manufactured, substantially from plastic by injection molding and/or compression molding, wherein the top deck is attached to the bearing construction and wherein supporting elements are received in the top deck, the bearing construction and/or between the top deck and the bearing construction.

20. A method according to claim 19, wherein the supporting elements are manufactured from a material deviating from the plastic from which top deck and bearing construction have been manufactured, such that in the assembled pallet, the supporting elements exhibit a different creep than the top deck and the bearing construction.

21. A method for transporting rolling containers, wherein the rolling containers are positioned on pallets according to claim 13, wherein the rolling containers with the pallets are taken up and transported, optionally stacked on comparable assemblies of pallets and rolling containers, whereupon the pallets are laid on a floor, optionally on a push-out device, whereupon the rolling containers are rolled from the pallets.

22. An assembly of a pallet according to claim 16 and a push-out device, wherein the push-out device is provided with ejector elements which can be inserted through openings into the pallet when the pallet is laid on the ejector device such that a rolling container placed on the pallet is thereby slightly lifted, at least one pair of wheels of the rolling container in the recesses is pushed upwards.

23. A method for transporting rolling containers, wherein the rolling containers are positioned on pallets in an assembly formed according to claim 16, wherein the rolling containers with the pallets are taken up and transported, optionally stacked on comparable assemblies of pallets and rolling containers, whereupon the pallets are laid on a floor, optionally on a push-out device, whereupon the rolling containers are rolled from the pallets.
